(19) United States
(12) Patent Application Publication
(10) Pub. No.: US 2009/0058595 A1
(43) Pub. Date: Mar. 5, 2009

(54) Biometric Control Device

(75) Inventors: Jean-Francois Mainguet, Grenoble (FR); Bruno Charrat, Saint Egreve (FR)

Correspondence Address: FISH & RICHARDSON P.C., PO BOX 1022, MINNEAPOLIS, MN, 55440-1022, US

(73) Assignee: ATMEL CORPORATION, Fribourg (CH)

(21) Appl. No.: 11/847,880

(22) Filed: Aug. 30, 2007

(51) Int. Cl. G05B 19/00

(52) U.S. Cl. 340/5.53

(57) ABSTRACT

Systems and methods for a biometric control device. Actuation of a control device can include direction information which can be used to generate a control signal associated with the actuation. Control signals can facilitate user functions on a recipient device.

### BACKGROUND

This disclosure relates to control devices.

Control devices, such as, e.g., a remote control, can be used to interface to other devices. These other devices can include devices such as televisions, radios, receivers, set top boxes, digital video disc (DVD) players, video cassette recorders (VCRs), car alarms, keyless entry systems, etc. Control devices can communicate with these electronic devices using various communications mechanisms. These communications mechanisms can include infrared (IR) communications, radio frequency (RF) communications, wireline communications, etc.

Some control devices have added functionality to provide authentication for users. For example, some remote controls include a fingerprint scanner to authenticate the user.

### SUMMARY

The disclosure herein relates to biometric control devices. Biometric data related to different types of physical stimuli, e.g., a scanning of a fingerprint and a swiping of a fingerprint, can be collected. In one aspect, the biometric data can include directional data, e.g., related to the direction of a fingerprint scan. The directional data can be used to generate a control signal, e.g., a channel change or volume change.

The details of one or more embodiments of the invention are set forth in the accompanying drawings and the description below. Other features, objects, and advantages of the invention will be apparent from the description and drawings, and from the claims.

Systems, methods and apparatuses for biometric control devices are provided. Systems can include a directional fingerprint recognition module, a control module, and a communication subsystem. The directional fingerprint recognition module can detect an actuation of the device, the actuation including identification information and direction information. The control module can generate a remote control signal based on the identification information and the direction information associated with the actuation, while the communication subsystem can communicate the remote control signal to a recipient device. The remote control signal can facilitate control of user functions associated with the recipient device

Computer implemented methods of this disclosure can include: detecting an actuation, the actuation comprising identification information and direction information; comparing the identification information associated with the detected actuation to stored identification information; and, signaling a remote control command based upon the comparison and the direction information; wherein the remote control command facilitates the operation of user functions on a recipient device.

### BRIEF DESCRIPTION OF FIGURES

FIG. 1 is a block diagram depicting an example biometric control device.

FIG. 2 is a block diagram depicting another example of a biometric control device.

FIG. 3 is a block diagram depicting another example of a biometric control device.

FIGS. 4A-C depict block diagrams showing an example of an ergonomic biometric control device.

FIG. 5 is a block diagram depicting an example of a biometric keyless entry device.

FIG. 6 is a block diagram depicting example components associated with a biometric control device.

FIG. 7 is a flowchart illustrating an example method of providing biometric control.

FIG. 8 is a flowchart illustrating an example method of providing control commands based upon user preferences responsive to biometric actuation.

### DETAILED DESCRIPTION

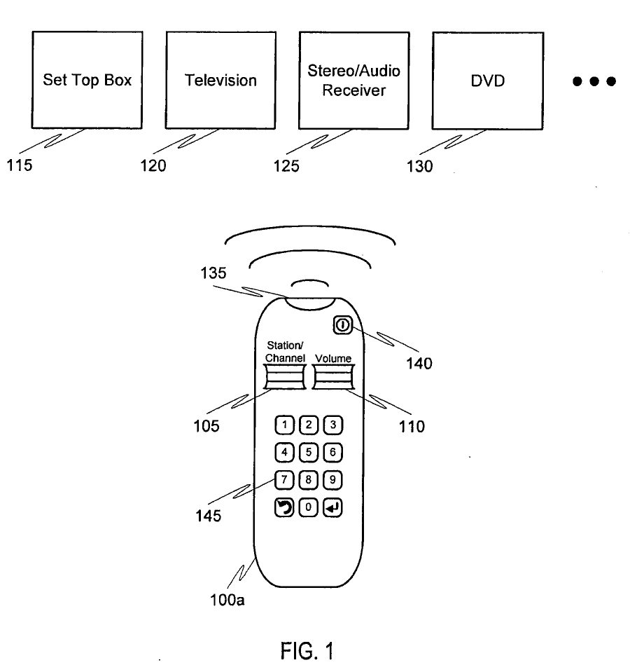

FIG. 1 is a block diagram depicting an example authenticated control device 100a. In some implementations, an authenticated control device 100a can be provided by integrating one or more fingerprint scanners (e.g., fingerprint scanners 105, 110) with a control device. In some implementations, fingerprint scanners can implement both an authentication mechanism and an input mechanism (e.g., similar to actuation of a button) for the control device 100a. In some implementations, the control device 100a can provide control signals which are based user preferences. The user preferences, for example, can be based upon the identity of an authenticated user.

In some implementations, the control device 100a can be used to control other devices, including, e.g., a set top box 115, a television 120, a stereo/audio receiver 125, a digital video disc (DVD) player 130, among others. In some implementations, the control signals can be communicated using an infrared transmitter 135. In other implementations, the control signals can be communicated using any of a variety of communication means including carrier waves (e.g., radio frequency signals of various protocols (e.g., 802.11x, BlueTooth, etc.)) or wireline signals using various protocols. Other communications mechanisms are possible.

A control device 100a can include a number of input mechanisms (e.g., buttons), such as, for example, a power button 140 and a numeric keypad 145. Other buttons, such as, for example, menu buttons, navigation buttons, a mute button, info button, etc., can be included in various implementations. In some implementations, the channel up/down and/or volume up/down functionality can be provided by one or more fingerprint scanners 105, 110.

Upon sensing an actuation of a fingerprint scanner 105 (e.g., including scans of fingers and/or other digits that can be uniquely or substantially uniquely recognized, such as, e.g., thumbs, palms, etc.), the control device 100a can access a data store to determine if the user is a known user of the control device 100a. For example, a control device 100a can be configured to recognize each member of a family. The data store can include one or more fingerprints of known users. In some implementations, minutiae points associated with a scanned fingerprint can be compared to minutiae points of stored fingerprints to determine whether the user associated with the actuation is a known user. In other implementations, patterns associated with fingerprint ridges can be compared to known patterns of fingerprint ridges to determine whether the user is known or unknown. In various implementations, different fingerprint scanning methods can be used, including optical scanning, thermal scanning, ultrasonic scanning, passive capacitance scanning, active capacitance scanning, or radio frequency (RF) field scanning, among others. In some implementations, a sweep type scanner where the user moves his/her finger across the scanner can be used to detect the authentication/security information and user control/direction information associated with a user signaling an actuation of an associated function.

In some implementations, a direction associated with the actuation of the fingerprint scanner 105 can be used to derive user command information associated with the actuation. For example, if the fingerprint scanner 105 senses a fingerprint scan in a downward direction, a down channel change request can be inferred. Similarly, if the fingerprint scanner 105 senses a fingerprint scan 105 in an upward direction, an up channel change request can be inferred. In some implementations, transmission of such control commands can be based upon recognition of the fingerprint associated with the fingerprint scan.

In further implementations, known users can be provided a personalized menu (e.g., preferred channel mapping, channel guide preferences, etc.) based on the identity of the user. For example, a first person might prefer business channels, and the personalized menu might provide these channels first. Similarly, a second person may prefer dramatic movies, and the personalized menu can be programmed to provide movie channels as a priority. In some implementations, channels can be excluded from the remote. For example, a user might dislike the shopping channels, and program the remote to exclude those channels. Moreover, in other examples, parents can program the remote to control their children's access to certain channels or even certain types of programming (e.g., based upon programming information, such as ratings received from media service). In some implementations, the control device 100a can include a communication interface to retrieve programming information from an associated device or the internet.

In some implementations, a single user can create multiple personalized menus based upon the input selection means (e.g., which finger is provided for the fingerprint scan). For example, a user might use an index finger or thumb to access sports channels or content, while using a middle finger to access news and business channels or content, or a ring finger to access movie channels (e.g., premium channels) or content. Furthermore, in some implementations, the menus can only be invoked by use of a security actuation. For example, particular channels might be made accessible only by use of the security actuation. For example, a user might use his/her pinky finger as his/her “security actuation,” and program the remote to provide access to secured channels or content based upon actuation using his/her security actuation. In some implementations, a security actuation can include a combination of multiple fingerprint scans. For example, a user might program the control device 100a to provide a secret menu based upon sensing a channel up scan with an index finger and a volume down scan with a middle finger. In other implementations, the security actuation can include entry of a personal identification number (PIN) combination used to access a secret menu.

In some implementations, unrecognized users can be denied permission to use the control device 100a. In other implementations, a user that is not recognized can be provided a generic (e.g., non-personalized) menu. The generic menu could be set up by an authorized user to limit access to certain channels. For example, an owner might not want his/her guests to have the ability to order pay-per-view movies or other events (e.g., sporting events). Thus, the owner could limit access of the generic menu to those channels the owner authorizes using the control device 100a.

In some implementations, one or more fingerprint scanners can be used without providing personalized menus or authentication functionality. In such implementations, the fingerprint scanner can be used to sense direction associated with a fingerprint scan, while ignoring any minutiae points or fingerprint patterns. Thus, in some examples, any user could actuate the fingerprint scanner using control device 100a, and the control device can generate a control signal based upon the actuation of the fingerprint scanner.

In some implementations, a volume control fingerprint scanner 110 can be included in the remote device 100a. In such implementations, receipt of an actuation scan can include both fingerprint information and direction information. In such implementations, the fingerprint information can be used for authentication purposes, while the direction information can be used for control command purposes. For example, an actuation of the scanner sensor 110 in a downward direction across the scanner 110 can be used to authenticate the user associated with the fingerprint scan and to provide a command associated with the actuation of the scanner 110. Further, in some implementations, the user can adjust the settings associated with actuation of the scanner 110 to provide more coarse volume adjustment or finer volume adjustment. Moreover, in some implementations, the finger used to actuate the scanner can indicate whether the user is requesting coarse volume adjustment or fine volume adjustment. For example, a user might turn on a television to find that the previous viewer had the volume turned up. The user might want to turn the volume down quickly. To do so, the user can use an index finger to provide coarse volume adjustment. When the volume has been reduced to approximately the level desired by the user, the user can use a middle finger or thumb to provide fine tuning of the volume to the desired level.

In some implementations, the control device 100a can be used to implement a payment system for using an associated electronic device. For example, the user could be required to enter payment information (e.g., a credit card number and/or personal identification number (PIN)) prior to accessing an associated device (e.g., a television). In further implementations, the control device 100a could communicate the payment information and associated fingerprints to a clearinghouse (e.g., a credit card company) to authenticate the transaction. Thus, in such implementations, the clearinghouse can deny access to a user based on receiving payment information that does not match stored fingerprints associated with the payment information. In these implementations, the control device can provide two way communications, for example, using an Institute of Electrical and Electronics Engineers (IEEE) 802.11x standard to communicate payment information and fingerprint scans and to receive notification of authentication of the payment information. The control device can then provide access to a requested service (e.g., a television service).

In some implementations, the control device might not include a separate volume scanner 110. In one such implementation, scanner 105 can provide both channel change functionality and volume change functionality. For example, the scanner 105 can be configured to recognize a substantially vertical actuation of the scanner to signal a channel change, and can be configured to recognize a substantially horizontal actuation of the scanner to signal a volume change. In some of these examples, the actuation might have both a vertical and horizontal component. In some implementations, the control device 100a can determine a primary direction of movement and signal an appropriate actuation. In other implementations, the control device 100a can signal based upon a vertical and/or component the actuation reaching a threshold magnitude. In still further implementations, the control device 100a can disregard an actuation based upon both vertical and horizontal actuations being received simultaneously. In some implementations, the scanner 105 can authenticate the user and/or provide special menus based upon the fingerprint associated with a vertical fingerprint scan. In these implementations, the horizontal (e.g., volume) actuation might not require authentication.

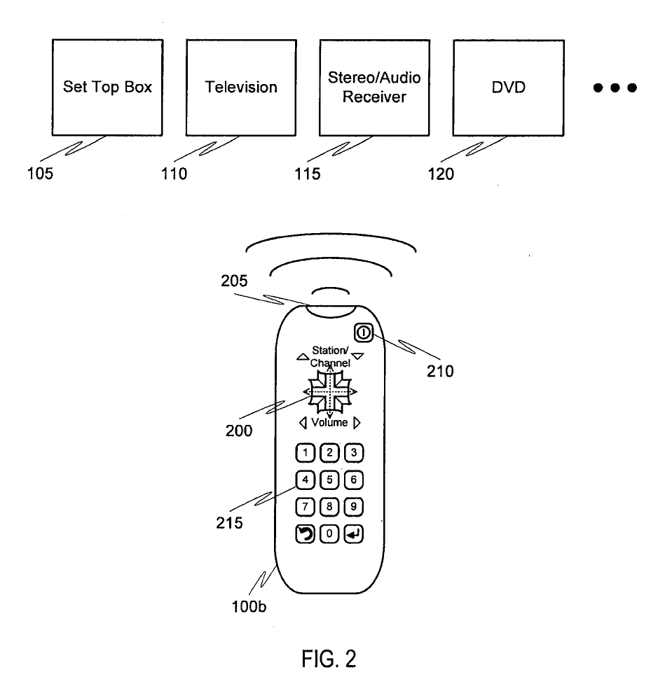

FIG. 2 is a block diagram depicting another example of a biometric control device 100b. In some implementations, the control device 100b can be configured to provide a combination fingerprint scanner 200. In some implementations, the combination fingerprint scanner 200 can be configured to provide fingerprint scanning capabilities in multiple directions. For example, the fingerprint scanner 200 can be used to detect a fingerprint and an up/down or left/right direction associated with an actuation of the fingerprint scanner 200. In some implementations, the fingerprint scanner can determine a primary direction associated with an actuation and ignore a secondary direction associated with the actuation. For example, a user might intend to actuate the fingerprint scanner in a direction to the right (e.g., indicating a request to increase volume), while accidentally providing partial up or down actuation. In these implementations, the control device can determine intent of the user based upon comparing the primary direction of the actuation.

In other implementations, the control device 100b can use both a primary and a secondary direction to determine one or more control signals to transmit to an associated device (e.g., electronic devices 105-120). For example, a user might want to indicate both an increase volume request and a channel down request simultaneously. In those implementations which detect both a primary and a secondary direction, the control device 100b can signal both the channel change and volume change commands (e.g., substantially simultaneously). Other implementations are possible.

In some implementations, other non-authenticated functions can be provided by the control device. For example, the control device 100b can include a transmitter configured to transmit a wireless signal to any associated electronic devices 105-120. Moreover, the control device can include a power button 210, and a numeric keypad 215. The power button can be used to request a stand-by or power up to one or more of the associated electronic devices 105-120. The numeric keypad 215 can be used to provide numeric input to any of the one or more associated electronic devices 105-120.

In some implementations, the scanner 200 can include just a single biometric sensor that can sense vertical and horizontal actuations of the scanner 200. For example, a single swipe scanner can be included. In such examples, the single swipe scanner can be placed in the horizontal position, while the vertical portion of the cross associated with the scanner 200 can be implemented to provide guidance to the user for users to make a horizontal actuation of the single swipe scanner. In some such implementations, the vertical actuation of the single swipe scanner can be used to authenticate the user or to provide personalized control menus, while the horizontal actuation of the single swipe scanner might provide no authentication functionality for, for example, the volume adjustment.

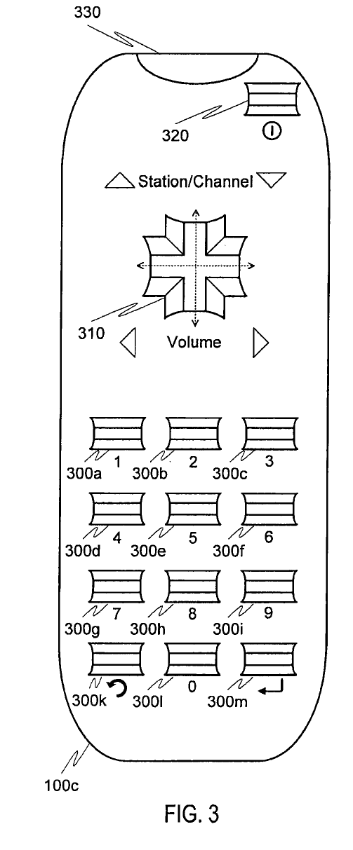

FIG. 3 is a block diagram depicting another example of a biometric control device 100c. In some implementations, the authenticated control device 100c can provide security for each of the input means (e.g., buttons) included on the control device 100c. In such implementations, the control device 100c can include a combination fingerprint scanner 310, operable to detect an actuation and a plurality of minutiae points associated with the actuation, and to detect a direction associated with the actuation. The minutiae points can be compared to minutiae points included in a data store. The data store can include minutiae points associated with known users. If the scanned minutiae points match any set of stored minutiae points the user associated with the actuation is authenticated. If the scanned minutiae points do not match any set of stored minutiae points, the user associated with the actuation is unknown.

In some implementations, the direction associated with the actuation can be used to determine a requested command associated with the actuation of the fingerprint scanner 310. In further implementations, the command associated with the actuation of the fingerprint scanner 310 can be based upon preferences associated with the particular user identified by the actuation (e.g., based upon matching the minutiae points of the actuation to a stored set of minutiae points).

In some implementations, buttons included in a numeric keypad (e.g., fingerprint scanners 300a-m) and/or power button 320 can include authentication mechanisms. In such implementations, the fingerprint scanners 300a-m, 320 can detect an actuation associated with a button, determine the authenticity of the actuation based upon comparison of the scanned fingerprint (e.g., scanned minutiae points) to stored fingerprint(s) (e.g., stored minutiae points), and signal a control command based upon the authentication of the actuation.

In some implementations, the user can authenticate the control device 100c based upon provision of a PIN matched to one or more fingerprints. In some implementations the actuation of the numbers in the PIN can be associated with specific fingers. For example, a user having a pin of “1234” can associate the “1” actuation with a right pinky finger, the “2” actuation with a left index finger, the “3” actuation with a left thumb, and the “4” actuation also with the left index finger. In some implementations, entry of the correct PIN combination can provide the user with access to the device for a specified period of time (e.g., 30 minutes from the last authenticated command). In further implementations, the control device 100c can continue to inspect the actuations to ensure that the user associated with the most recent PIN combination is associated with the actuations. In some implementations, the control device can prevent other users from accessing the control device 100c until the user associated with the most recent PIN combination is logged out of the control device 100c (e.g., through non-use, entry of a logout sequence, etc.).

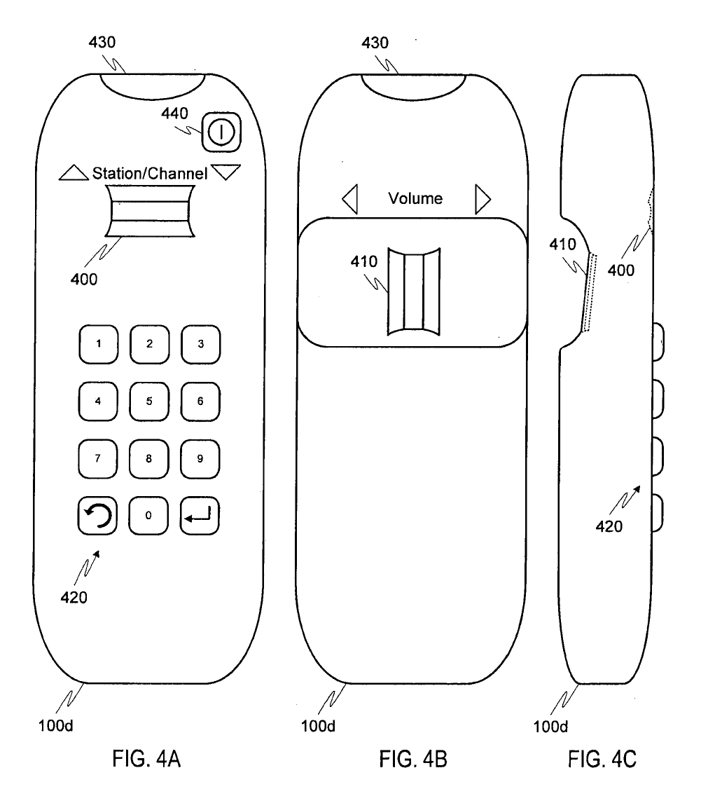

FIGS. 4A-C depict block diagrams showing an example of an ergonomic authenticated control device 100d. In some implementations, a control device 100d can be configured to provide a user with a comfortable interface. For example, in some implementations, a channel change might be actuated using a thumb in reference to a channel change fingerprint scanner 400. The index finger might wrap around the control device 100d in such examples. In some implementations, the index finger can be used to actuate a volume control fingerprint scanner 410. The user can thereby access both the channel change functionality and the volume control functionality with relatively little effort.

The control device 100d can also include a numeric keypad 420 including buttons numbered “0” through “9.” In some implementations, the buttons can be replaced by fingerprint scanners, similar to the example implementation shown in FIG. 3. The power button 430 can provide the user with an interface to power-down, standby, or power-up an associated device. In some implementations, the power button can be replaced by a fingerprint scanner, similar to the example implementations shown in FIG. 3.

In various implementations, the orientation of the fingerprint scanners 400, 410 can be adjusted based upon ergonomic functionality. For example the volume adjustment fingerprint scanner 410 can be placed at an angle to provide a more comfortable position for holding the remote control and actuating the control signals associated volume adjustment fingerprint scanner 410.

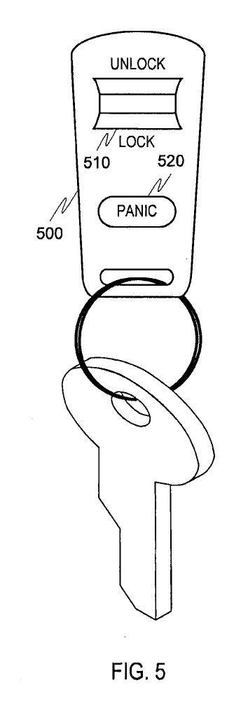

FIG. 5 is a block diagram depicting an example of a control device, such as, for example, an authenticated keyless entry device 500. In some implementations, the keyless entry device can provide keyless entry to an associated vehicle based upon an actuation received from a known user. A fingerprint scanner 510 can be used to receive an actuation. The actuation can include fingerprint information (e.g., a number of scanned minutiae points) and direction information associated with the actuation. The fingerprint information associated with the actuation can be compared to one or more sets of known fingerprint information stored in a data store. In some implementations, the keyless entry device 500 can signal an actuation of the car door locks based upon the comparison of the fingerprint information associated with the actuation and based upon the direction associated with the actuation. For example, if a car owner scans his/her fingerprint in an upward direction on the fingerprint scanner, the keyless entry device 500 can authenticate the car owner based upon the actuation and can signal an unlock command based upon authentication and the direction associated with the actuation.

In some implementations, the keyless entry device 500 can include a panic button 520. The panic button 520 in various implementations can signal an alarm. The alarm can include, for example, a car alarm, calling the police for help, or disabling the car, among others. In some implementations, the panic functionality could be provided by a fingerprint scanner, thereby authenticating the actuation of the panic button 520. Other implementations of a keyless entry system are possible.

In various implementations, the actuation modules can be used to provide authenticated actuation of other electronic devices, such as, for example, mobile devices, including mobile communications devices and mobile computing devices.

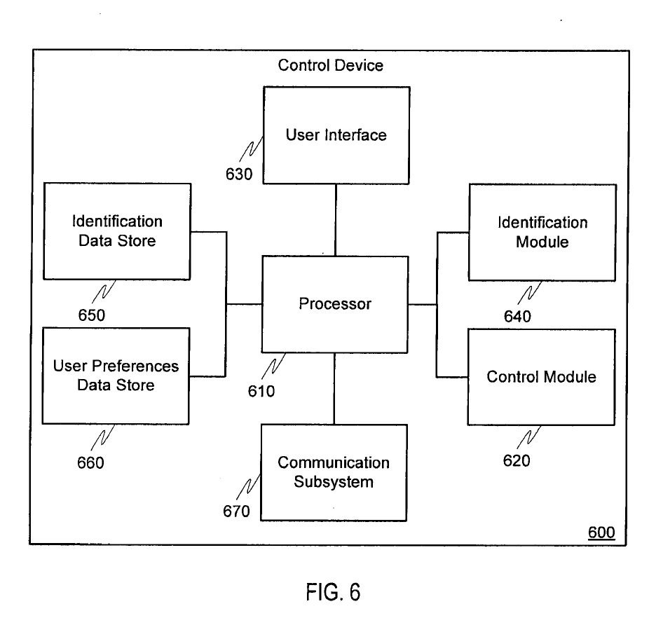

FIG. 6 is a block diagram depicting components associated with an authenticated control device 600. The authenticated control device can include a processor 610 operable to provide functionality based upon programming associated with the control device 600. In some implementations, the programming can include, for example, an operating system (e.g., control module 620). The operating system, in various examples, can provide the processor with information about how to process inputs received from users.

Inputs can be received, for example, through a user interface 630. In some implementations, the user interface 630 can include one or more fingerprint scanners. The fingerprint scanners can be used, for example, to capture identification information (e.g., minutiae points or fingerprint patterns) associated with an actuation of the fingerprint scanner. In various implementations, the fingerprint scanning functionality can be provided using any of a myriad of available fingerprint scanning technologies, including thin film transistor fingerprint scanning technologies, charged coupled devices (CCDs), complementary metal oxide semiconductor (CMOS) camera/sensor, or pyroelectric sensors (e.g., polyvinylidene fluoride (PVFD), among many others.

In some implementations, the control device 600 can also include an identification module 640 operable to retrieve known identification information from an identification data store 650. The identification module 640 can use the identification information associated with the user and the known identification information to determine whether the user is recognized. In some implementations, the identification of the user is a predicate to communication of control commands to an associated device. In other implementations, the identification of a user merely provides specialized menus for the user based upon the identification. In still further implementations, the identification of the user can serve as a predicate to communication of control commands, and provide specialized menus based upon the identification of the user issuing the commands.

In some implementations, specialized menus including user preferences can be retrieved from a preferences data store 660. In such implementations, the control module 620 can interpret an input based upon preferences associate with a user (or finger) being used to actuate the control device. For example, if the identification module has identified a first fingerprint, the operating system can retrieve preferences associated with the first fingerprint and signal a command based upon the preferences associated with the first fingerprint.

In some implementations, the command can be communicated to a receiving device using a communication subsystem 670. The communication subsystem 670 can include a wireless or wired connection to a receiving device. In various implementations, wireless communication mechanisms can include infrared, any of a variety of 802.11x standards, Bluetooth standards, or any other suitable wireless communication mechanism.

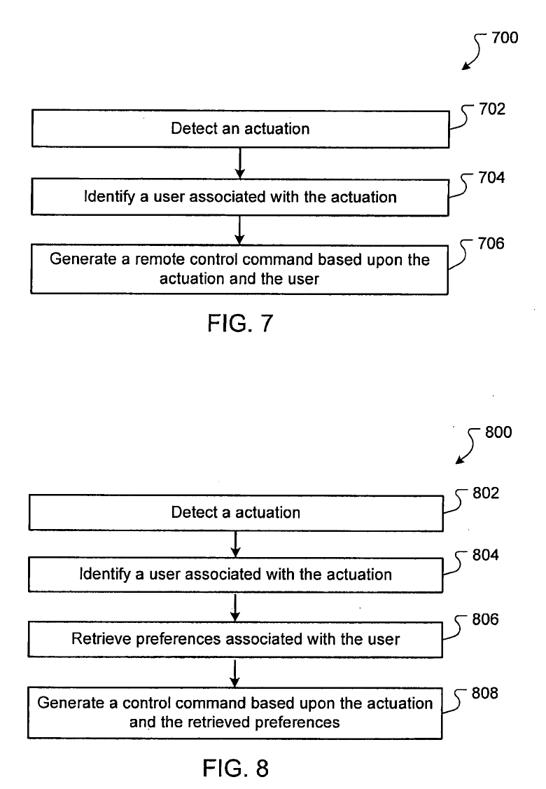

FIG. 7 is a flowchart illustrating an example method 700 of providing authenticated control. At stage 702 an actuation is detected. The actuation can be detected, for example, by a fingerprint scanner (e.g., fingerprint scanner 105, 110 of FIG. 1). In some implementations, the actuation can include identification information and direction information. In some implementations, the identification information can be used to provide security functionality for a device. For example, identification information such as a fingerprint scan can be compared to known identification information such as stored fingerprint information to identify a user associated with the actuation. The direction information can be used to signal user control commands to a receiving device. In some implementations, the direction information can be interpreted based upon a private menu, which can include, for example, user preferences.

At stage 704, a user associated with the actuation can be identified. The user can be identified, for example, using an identification module (e.g., identification module 640 of FIG. 6). In some implementations, the identification module can compare identification information associated with the actuation with known identification information. For example, a fingerprint scan can include a number of minutiae points or a pattern associated with the fingerprint scan. The pattern or minutiae points can be compared with known patterns or sets of minutiae points to determine a match between the scanned fingerprint and a known user.

At stage 706, a remote control command can be generated based upon the actuation and the user. The remote control command can be signaled, for example, by a communication subsystem (e.g., communication subsystem 670 of FIG. 6). In some implementations, the remote control command can be signaled by an operating system (e.g., control module 620 of FIG. 6) operating in conjunction with a processor (e.g., processor 610 of FIG. 6) and the communication subsystem. In some implementations, the remote control command can be signaled using an infrared transmitter to a recipient device. In further implementations, the remote control signal can facilitate control or actuation of user functions associated with the recipient device.

FIG. 8 is a flowchart illustrating an example method 800 of providing control commands based upon user preferences responsive to authentication. At stage 802 an actuation is detected. The actuation can be detected, for example, by a user interface (e.g., user interface 630 of FIG. 6). In some implementations, the user interface can include a fingerprint scanner, such as a sweep fingerprint scanner used to detect an actuation. In those implementations including a sweep fingerprint scanner, the actuation can include identification information and direction information. In some implementations, the identification information can be used to provide security functionality for a device. For example, identification information such as a fingerprint scan can be compared to known identification information such as stored fingerprint information to identify a user associated with the actuation. The direction information can be used to signal user control commands to a receiving device. In some implementations, the direction information can be interpreted based upon a private menu, which can include, for example, user preferences.

At stage 804, a user associated with the actuation can be identified. The user can be identified, for example, using an identification module (e.g., identification module 640 of FIG. 6). In some implementations, the identification module can compare identification information associated with the actuation with known identification information. For example, a fingerprint scan can include a number of minutiae points or a pattern associated with the fingerprint scan. The pattern or minutiae points can be compared with known patterns or sets of minutiae points to determine a match between the scanned fingerprint and a known user.

At stage 806, preferences associated with the identified user can be retrieved. Preferences can be retrieved, for example, from a preferences store (e.g., preferences store 660 of FIG. 6). The preferences can be interpreted, for example, by a processor (e.g., processor 610 of FIG. 6) in conjunction with an operating system (e.g., control module 620 of FIG. 6). In some implementations, the preferences can include preferences to provide certain channels or exclude certain channels in response to a channel change request. Preferences can also include preferences regarding how coarse or fine to signal a volume adjustment. In some implementations, a single user can have multiple preferences saved based upon which finger is used or how the user actuates a control device.

At stage 808, a remote control command can be signaled based upon the actuation and based upon retrieved preferences. The remote control command can be signaled, for example, by a communication subsystem (e.g., communication subsystem 670 of FIG. 6). In some implementations, the remote control command can be signaled by an operating system (e.g., control module 620 of FIG. 6) operating in conjunction with a processor (e.g., processor 610 of FIG. 6) and the communication subsystem. In some implementations, the preferences can be based upon information associated with the actuation. For example, the user can use a first finger to access a first group of channels, a second finger to access a second group of channels, etc.

The apparatus, methods, flow diagrams, and structure block diagrams described in this patent document can be implemented in computer processing systems including program code comprising program instructions that are executable by the computer processing system. Other implementations can also be used. Additionally, the flow diagrams and structure block diagrams described in this patent document, which describe particular methods and/or corresponding acts in support of steps and corresponding functions in support of disclosed structural means, can also be utilized to implement corresponding software structures and algorithms, and equivalents thereof.

The apparatus, methods, flow diagrams, and structure block diagrams described in this patent document can be implemented in computer processing systems including program code comprising program instructions that are executable by the computer processing system. Other implementations can also be used. Additionally, the flow diagrams and structure block diagrams described in this patent document, which describe particular methods and/or corresponding acts in support of steps and corresponding functions in support of disclosed structural means, can also be utilized to implement corresponding software structures and algorithms, and equivalents thereof.

The methods and systems described herein may be implemented on many different types of processing devices by program code comprising program instructions that are executable by one or more processors. The software program instructions may include source code, object code, machine code, or any other stored data that is operable to cause a processing system to perform methods described herein.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. It is also noted that software instructions or a module can be implemented for example as a subroutine unit of code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art can effect alterations, modifications and variations to the examples without departing from the scope of the invention.

1. A remote control device comprising:
a directional fingerprint recognition module operable to detect an actuation associated with a user of the remote control device, the actuation comprising biometric information and direction information;
a control module operable to generate a remote control signal based on the biometric information and the direction information associated with the actuation; and
a communication subsystem operable to communicate the remote control signal to a recipient device;
wherein the remote control signal facilitates control of user functions associated with the recipient device.

2. The device of claim 1, further comprising an identification module operable to determine if the actuation is associated with one or more authorized users, wherein the communication subsystem operates based upon the identification module.

3. The device of claim 2, wherein the control module is further operable to select between one or more menus associated with the one or more authorized users and a generic menu based upon an actuation associated with other users.

4. The device of claim 3, wherein the control module is further operable to select from among the one or more menus based upon which of the one or more authorized users is associated with the detected actuation.

5. The device of claim 3, wherein the one or more menus comprise preferences associated with each of the respective one or more authorized users.

6. The device of claim 5, further comprising a user interface operable to enable the user to adjust the preferences associated with the authorized user by requesting adjustment of a channel lineup associated with the user.

7. The device of claim 1, wherein the remote control device is operable to signal a channel change based upon the direction information associated with the actuation.

8. The device of claim 1, wherein the remote control device is operable to signal a volume change based upon the direction associated with the actuation.

9. The device of claim 1, wherein the directional fingerprint recognition module comprises a first fingerprint reader operable to scan a fingerprint responsive to a user sliding a finger across the first fingerprint reader.

10. The device of claim 9, further comprising comparing minutiae points associated with the scanned fingerprint to one or more sets of stored minutiae points associated with recognized users.

11. The device of claim 10, further comprising authenticating a user based upon the comparison.

12. The device of claim 10, further comprising retrieving one or more preferences based upon the comparison.

13. The device of claim 9, wherein the directional fingerprint recognition module further comprises a second fingerprint reader operable to scan a fingerprint responsive to a user sliding a finger across the second fingerprint reader.

14. The device of claim 1, wherein the control module is operable to access a predetermined menu based upon the actuation being associated with a security actuation associated with a particular user from among the one or more authorized users.

15. The device of claim 1, wherein:
if the direction information comprises a first direction, the actuation comprises a channel change request; and
if the direction information is a second direction, the actuation comprises a volume change request.

16. The device of claim 1, wherein the directional fingerprint recognition module detects whether an actuation is associated with one or more authorized users by comparing a detected fingerprint with a plurality of known fingerprints associated with the one or more authorized users.

17. The device of claim 1, further comprising an identification module operable to identify a user based on the biometric information.

18. The device of claim 17, wherein the user comprises an authorized user, and the identification module is further operable to authenticate the authorized user.

19. The device of claim 18, wherein the control module is operable to access a user preferences data store based upon identification of an authorized user, the user preferences data store being operable to provide personalized preferences based upon the identity of the user.

20. The device of claim 17, wherein the user does not comprise an authorized user, and the identification module is further operable to provide a generic menu to the user.

21. The device of claim 1, wherein the control module is operable to recognize a security actuation associated with the remote control device.

22. The device of claim 21, wherein the control module is further operable to restrict access to the remote control device to a user associated with the security actuation based upon receiving the security actuation.

23. The device of claim 22, wherein the control module is operable to restrict access to the device for a period of time based upon receiving the security actuation.

24. The device of claim 24, wherein the period of time is measured from a last received authenticated command.

25. A computer implemented method comprising:
detecting an actuation, the actuation comprising biometric information and direction information;
comparing the biometric information associated with the detected actuation to stored biometric information; and
signaling a remote control command based upon the comparison and the direction information;
wherein the remote control command facilitates the operation of user functions on a recipient device.

26. The computer implemented method of claim 25, further comprising:
retrieving a personalized menu based upon the biometric information associated with the detected actuation.

27. The computer implemented method of claim 26, wherein the menu comprises a channel lineup associated with the biometric information associated with the detected actuation.

28. The computer implemented method of claim 27, further comprising adjusting the channel lineup based upon input received from a user associated with the biometric information.

29. The computer implemented method of claim 26, wherein a particular user has a plurality of personalized menus, each of the personalized menus being associated with a particular finger of the particular user.

30. The computer implemented method of claim 25, further comprising providing a generic menu based upon a user fingerprint associated with the actuation being unrecognized based upon comparison with stored fingerprints.

31. The computer implemented method of claim 25, further comprising retrieving one or more user preferences based upon the received actuation.

32. The computer implemented method of claim 31, further comprising retrieving public preferences based upon the biometric information associated with the actuation not being recognized.

33. The computer implemented method of claim 31, further comprising retrieving a first set of preferences based upon the biometric information being associated with the first set of preferences.

34. The computer implemented method of claim 25, further comprising adjusting user preferences associated with an identified user based upon input received from the identified user.
